(19) United States
(12) Patent Application Publication
(10) Pub. No.: US 2006/0250643 A1
(43) Pub. Date: Nov. 9, 2006

(54) Monitoring print status in distributed printing

(75) Inventors: Akira Matsumoto, Nagano-ken (JP); Toshihiro Shima, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/391,367

(22) Filed: Mar. 29, 2006

(30) Foreign Application Priority Data
Mar. 30, 2005 (JP) 2005-97334

(51) Int. Cl. G06F 3/12

(52) U.S. Cl. 358/1.15

(57) ABSTRACT

In a distributed printing system of the invention, a distributed printing control device receives a distribution print job or a print job for distributed printing from a print source device, specifies one or multiple distribution destination printing devices selected as distribution destinations of the distribution print job, and distributes the distribution print job to the one or multiple specified distribution destination printing devices. The distributed printing control device then creates distribution management information. The distribution management information correlates distribution destination identification information of each specified distribution destination printing device and a distribution destination job index allocated to each division of the distribution print job by the specified distribution destination printing device, to a distribution source job index allocated to the distribution print job in a receiving order of the distribution print job. In the distributed printing system of the invention, a distributed printing monitor device acquires the distribution management information created by the distributed printing control device, and extracts the distribution destination identification information of each specified distribution destination printing device, which receives each division of the distribution print job, from the acquired distribution management information. The distributed printing monitor device receives print job-related information regarding the distribution print job from the distribution destination printing device identified by the extracted distribution destination identification information. The distributed printing monitor device creates print status information representing the print status of each division of the distribution print job in each distribution destination printing device, based on the received print job-related information, and sends the created print status information to the print source device. This arrangement enables the user to monitor the print status of each distribution print job executed by the respective distribution destination printing devices.

### BACKGROUND OF THE INVENTION

1. Field of the Invention

The present invention relates to a technique of readily specifying distribution destination printing devices for distributed printing of a print job among multiple printing devices on a network and monitoring the print status of each division of the print job distributed to each of the specified distribution destination printing devices.

2. Description of the Related Art

In currently popular printing systems, each user is allowed to selectively use multiple printing devices connected to an identical network. A distributed printing technique applicable to such printing systems has been proposed to distribute a print job to plural printing devices for simultaneous distributed printing and thereby complete execution of the whole print job within a short time (see, for example, Japanese Patent Laid-Open Gazette No. 2002-215368).

One proposed distributed printing system adopting the distributed printing technique has a distributed printing control device, which is attached to or built in a specific printing device among the multiple printing devices on the network. The distributed printing control device receives a print job from a client as a print source device via the network, specifies available printing devices, which are on-line and satisfy other predetermined conditions, as distribution destination printing devices among the multiple printing devices on the network, and distributes the received print job to the specified distribution destination printing devices.

In this prior art distributed printing system, the distributed printing control device specifies the distribution destination printing devices after reception of the print job from the client. The user of the client is thus not informed of specification of the distribution destination printing devices among the multiple printing devices on the network.

The user often desires to check the print status of each division of the print job distributed to each distribution destination printing device. In a typical conventional procedure, the user individually opens multiple windows, which are provided by respective printer drivers installed in the client corresponding to the multiple printing devices on the network, on a display of the client. The user checks all the windows for the distribution of the print job, specifies the distribution destination printing devices, and then verifies the print status of the respective divisions of the print job executed by the specified distribution destination printing devices. This procedure undesirably bothers the user.

In the distributed printing system, the distributed printing control device may receive multiple print jobs simultaneously and distribute the respective print jobs to specified distribution destination printing devices. In this case, the user checks all the windows for the distribution of the print job, specifies the distribution destination printing devices, identifies the distributed print job, and then verifies the print status of the respective divisions of the identified print job executed by the specified distribution destination printing devices. This further requires the time and the labor of the user.

### SUMMARY OF THE INVENTION

The object of the invention is thus to eliminate the drawbacks of the prior art technique and to enable the user to monitor a print status of each distribution print job distributed to distribution destination printing devices specified by a distributed printing control device.

In order to attain at least part of the above and the other related objects, the present invention is directed to a distributed printing control device that distributes each distribution print job or each print job for distributed printing, which is received from a print source device via a network, to one or multiple distribution destination printing devices selected as distribution destinations of the distribution print job among plural printing devices on the network.

The distributed printing control device includes: a distribution management module that receives a distribution print job, specifies one or multiple distribution destination printing devices, and creates distribution management information, where the distribution management information correlates distribution destination identification information of each specified distribution destination printing device and a distribution destination job index allocated to each division of the distribution print job by the specified distribution destination printing device, to a distribution source job index allocated to the distribution print job in a receiving order of the distribution print job; and a distribution execution module that distributes the distribution print job to the one or multiple specified distribution destination printing devices.

The distributed printing control device of the invention creates the distribution management information. The distribution management information correlates the distribution destination identification information of each specified distribution destination printing device and the distribution destination job index allocated to each division of the distribution print job by the specified distribution destination printing device, to the distribution source job index allocated to the distribution print job in the receiving order of the distribution print job. The distribution management information enables easy identification of both the print source device that has sent a certain distribution print job and the distribution destination printing devices that have received respective divisions of the certain distribution print job. The distribution management information is used for monitoring a print status of each division of the distribution print job in each specified distribution destination printing device.

In the distributed printing control device of the invention, it is preferable that the distribution management module stores the created distribution management information and, in response to a transmission request of the distribution management information from a distributed printing monitor device on the network, sends the stored distribution management information to the distributed printing monitor device.

The distributed printing monitor device receives the distribution management information and is thus readily notified of the distribution destination printing devices specified as the distribution destinations of each distribution print job. This arrangement enables the distributed printing monitor device to monitor the print status of each division of the distribution print job in each specified distribution destination printing device.

In one preferable embodiment of the invention, the distributed printing control device further includes a print status information creation module that receives from the print source device a transmission request of print status information representing a print status of each division of the distribution print job in each distribution destination printing device, extracts the distribution destination identification information of each specified distribution destination printing device from the distribution management information, acquires print job-related information regarding the distribution print job from the distribution destination printing device identified by the extracted distribution destination identification information, creates the print status information based on the acquired print job-related information, and sends the created print status information to the print source device.

In response to the transmission request of the print status information received from the print source device, the distributed printing control device of this embodiment creates the print status information and sends the created print status information to the print source device. The print source device can thus readily monitor the print status of each division of the distribution print job in each specified distribution destination printing device.

The distribution source job index is preferably an exclusive index number sequentially allocated to each distribution print job in its receiving order.

The distribution source job index of this arrangement ensures easy identification of each distribution print job.

The distributed printing control device may be incorporated in or connected to at least one specific printing device among the plural printing devices on the network.

Another application of the invention is a printing device that includes the distributed printing control device having any of the above configurations.

The present invention is also directed to a distributed printing monitor device that monitors a print status of each division of a distribution print job or a print job for distributed printing, which is sent via a network from a print source device to a distributed printing control device on the network, where the distributed printing control device specifies one or multiple distribution destination printing devices as distribution destinations of the distribution print job among plural printing devices on the network and distributes the distribution print job to the one or multiple specified distribution destination printing devices.

The distributed printing monitor device includes: a distribution management information acquisition module that acquires distribution management information created by and sent from the distributed printing control device, where the distribution management information correlates distribution destination identification information of each specified distribution destination printing device and a distribution destination job index allocated to each division of the distribution print job by the specified distribution destination printing device, to a distribution source job index allocated to the distribution print job in a receiving order of distribution print jobs; and a print status information creation module that extracts the distribution destination identification information of each specified distribution destination printing device, which receives each division of the distribution print job, from the acquired distribution management information, receives print job-related information regarding the distribution print job from the distribution destination printing device identified by the extracted distribution destination identification information, and creates print status information representing a print status of each division of the distribution print job in each distribution destination printing device, based on the received print job-related information.

The distributed printing monitor device of the invention receives the distribution management information and is thus readily notified of the distribution destination printing devices specified as the distribution destinations of each distribution print job. The distributed printing monitor device receives the print job-related information from each specified distribution destination printing device and creates the print status information based on the received print job-related information. The distributed printing monitor device can thus readily monitor the print status of each division of the distribution print job in each specified distribution destination printing device.

In one preferable embodiment of the invention, the distributed printing monitor device further includes a print status information transmission module that sends the created print status information to the print source device.

The distributed printing monitor device of this embodiment sends the created print status information to the print source device. The print source device is thus readily informed of the print status of the distribution print job sent by the print source device itself

In one preferable structure of the invention, the distributed printing monitor device is incorporated in the print source device.

The distributed printing monitor device further has a print status information display module that displays the created print status information.

This structure enables the print source device to refer to the distribution management information and to identify the distribution destination printing devices specified as the distribution destinations of each distribution print job. The print source device receives the print job-related information from each specified distribution destination printing device and creates the print status information based on the received print job-related information. The print source device can thus readily monitor the print status of each division of the distribution print job, which has been sent by the print source device itself, in each specified distribution destination printing device.

The present invention is also directed to a first distributed printing monitor system including plural printing devices, a distributed printing control device, and a distributed printing monitor device that are interconnected via a network. The distributed printing control device distributes a distribution print job or a print job for distributed printing, which is received from the print source device via the network, to one or multiple distribution destination printing devices selected as distribution destinations of the distribution print job among the plural printing devices on the network. The print source device is notified of a print status of each division of the distribution print job in each specified distribution destination printing device.

In the first distributed printing monitor system of the invention, the distributed printing control device receives the distribution print job, specifies one or multiple distribution destination printing devices, and distributes the distribution print job to the one or multiple specified distribution destination printing devices. The distributed printing control device creates distribution management information. The distribution management information correlates distribution destination identification information of each specified distribution destination printing device and a distribution destination job index allocated to each division of the distribution print job by the specified distribution destination printing device, to a distribution source job index allocated to the distribution print job in a receiving order of the distribution print job.

In the first distributed printing monitor system of the invention, the distributed printing monitor device acquires the distribution management information created by the distributed printing control device, and extracts the distribution destination identification information of each specified distribution destination printing device, which receives each division of the distribution print job, from the acquired distribution management information. The distributed printing monitor device receives print job-related information regarding the distribution print job from the distribution destination printing device identified by the extracted distribution destination identification information, creates print status information representing the print status of each division of the distribution print job in each distribution destination printing device, based on the received print job-related information, and sends the created print status information to the print source device.

The present invention is further directed to a second distributed printing monitor system including plural printing devices, a distributed printing control device, and a distributed printing monitor device that are interconnected via a network. The distributed printing control device distributes a distribution print job or a print job for distributed printing, which is received from the print source device via the network, to one or multiple distribution destination printing devices selected as distribution destinations of the distribution print job among the plural printing devices on the network. The print source device is notified of a print status of each division of the distribution print job in each specified distribution destination printing device. The print source device has the distributed printing monitor device as a built-in component.

In the second distributed printing monitor system of the invention, the distributed printing control device receives the distribution print job, specifies one or multiple distribution destination printing devices, and distributes the distribution print job to the one or multiple specified distribution destination printing devices. The distributed printing control device creates distribution management information. The distribution management information correlates distribution destination identification information of each specified distribution destination printing device, a distribution destination job index allocated to each division of the distribution print job by the specified distribution destination printing device, and print source identification information, to a distribution source job index allocated to the distribution print job in a receiving order of the distribution print job.

In the second distributed printing monitor system of the invention, the distributed printing monitor device acquires the distribution management information created by the distributed printing control device, determines whether the print source identification information included in the acquired distribution management information matches with identification information of the print source device having the built-in distributed printing monitor device, and extracts, in response to matching as a result of the determination, the distribution destination identification information of each specified distribution destination printing device, which receives each division of the distribution print job, from the acquired distribution management information.

The distributed printing monitor device receives print job-related information regarding the distribution print job from the distribution destination printing device identified by the extracted distribution destination identification information, creates print status information representing the print status of each division of the distribution print job in each distribution destination printing device, based on the received print job-related information, and displays the created print status information on the print source device.

The present invention is also directed to a third distributed printing monitor system including plural printing devices, a distributed printing control device, and a distributed printing monitor device that are interconnected via a network. The distributed printing control device distributes a distribution print job or a print job for distributed printing, which is received from the print source device via the network, to one or multiple distribution destination printing devices selected as distribution destinations of the distribution print job among the plural printing devices on the network. The print source device is notified of a print status of each division of the distribution print job in each specified distribution destination printing device. The print source device has the distributed printing monitor device as a built-in component.

In the third distributed printing monitor system of the invention, the distributed printing control device receives the distribution print job, specifies one or multiple distribution destination printing devices, and distributes the distribution print job to the one or multiple specified distribution destination printing devices. The distributed printing control device creates distribution management information. The distribution management information correlates distribution destination identification information of each specified distribution destination printing device and a distribution destination job index allocated to each division of the distribution print job by the specified distribution destination printing device, to a distribution source job index allocated to the distribution print job in a receiving order of the distribution print job.

The distributed printing control device receives a print status information transmission request from the distributed printing monitor device, extracts the distribution destination identification information of each specified distribution destination printing device, which receives each division of the distribution print job, from the created distribution management information, and acquires print job-related information regarding the distribution print job from the distribution destination printing device identified by the extracted distribution destination identification information. The distributed printing control device creates print status information representing the print status of each division of the distribution print job in each distribution destination printing device, based on the acquired print job-related information, and sends the created print status information to the distributed printing monitor device.

In the third distributed printing monitor system of the invention, the distributed printing monitor device receives the print status information sent from the distributed printing control device in response to the print status information transmission request, and displays the received print status information on the print source device.

In any of the first through the third distributed printing monitor systems of the invention, the print source device can readily monitor the print status of each division of the distribution print job, which has been sent by the print source device itself, in each specified distribution destination printing device. Especially the first distributed printing monitor system of the invention enables the print source device separately provided from the distributed printing monitor device to be readily informed of the print status of the distribution print job.

The technique of the invention is not restricted to the distributed printing control device, the distributed printing monitor device, the printing device including the distributed printing control device, or any of the distributed printing monitor systems. The invention may be actualized by a distributed printing control method, a distributed printing monitor method, and distributed printing status monitoring methods, which respectively correspond to the distributed printing control device, the distributed printing monitor device, and the first through the third distributed printing monitor systems described above. There are diversity of other applications of the invention, for example, computer programs that are used to attain any of these devices, systems, and methods, recording media in which such computer programs are recorded, and data signals that include such computer programs and are embodied in carrier waves.

In the applications of the invention as the computer programs and the recording media in which the computer programs are recorded, the invention may be given as a whole program to control the distributed printing monitor device or the distributed printing control device or as a partial program to exert only the characteristic functions of the invention. Available examples of the recording medium include ROM cartridges, punched cards, prints with barcodes or other codes printed thereon, internal storage devices (memories like RAMs and ROMs) and external storage devices of the computer, and diversity of other computer readable media.

### BRIEF DESCRIPTION OF THE DRAWINGS

FIG. 1 schematically illustrates the configuration of a distributed printing system in a first embodiment of the invention;

FIG. 2 shows the structures of a distribution source printer, a distribution destination printer, and a distributed printing monitor device in the distributed printing system of FIG. 1;

FIG. 3 is a flowchart showing a distributed printing process executed by a distributed printing process module included in the distribution source printer;

FIG. 4 shows one example of a distribution result file;

FIG. 5 is a distribution result table showing distribution management information specified by the distribution result file of FIG. 4;

FIG. 6 is a flowchart showing a distribution management information acquisition process executed by a distributed printing monitor module included in the distributed printing monitor device of FIG. 2;

FIG. 7 is a flowchart showing a print status monitor process executed by the distributed printing monitor module;

FIG. 8 shows one example of print status information created based on print job-related information received from distribution destination printers;

FIG. 9 schematically illustrates the configuration of another distributed printing system in a second embodiment of the invention;

FIG. 10 shows the structures of a distribution source printer, a distribution destination printer, and a client having the functions of a distributed printing monitor device in the distributed printing system of FIG. 9;

FIG. 11 is a flowchart showing a distribution management information acquisition process executed by a distributed printing monitor module included in the client of FIG. 10;

FIG. 12 is a flowchart showing a print status monitor process executed by the distributed printing monitor module;

FIG. 13 schematically illustrates the configuration of still another distributed printing system in a third embodiment of the invention;

FIG. 14 shows the structures of a distribution source printer having part of the functions of a distributed printing monitor device, a distribution destination printer, and a client having a residual part of the functions of the distributed printing monitor device in the distributed printing system of FIG. 13;

FIG. 15 is a flowchart showing a print status monitor process executed by a distributed printing monitor module included in the client of FIG. 14; and

FIG. 16 is a flowchart showing a print status information creation process executed by a print status information creation module of a distributed printing process module included in the distribution source printer of FIG. 14.

### DESCRIPTION OF THE PREFERRED EMBODIMENTS

Some modes of carrying out the invention are described below as preferred embodiments in the following sequence:

A. First Embodiment

A1. System Configuration

A2. Structures of Printers and Distributed Printing Monitor Device

A3. Distributed Printing Process

A4. Distributed Printing Monitor Process

A5. Effects of Embodiment

B. Second Embodiment

B1. System Configuration

B2. Structures of Printers and Distributed Printing Monitor Device

B3. Distributed Printing Monitor Process

B4. Effects of Embodiment

C. Third Embodiment

C1. System Configuration

C2. Structures of Printers and Distributed Printing Monitor Device

C3. Distributed Printing Monitor Process

C4. Effects of Embodiment

D. Modifications

### A. First Embodiment

### A1. System Configuration

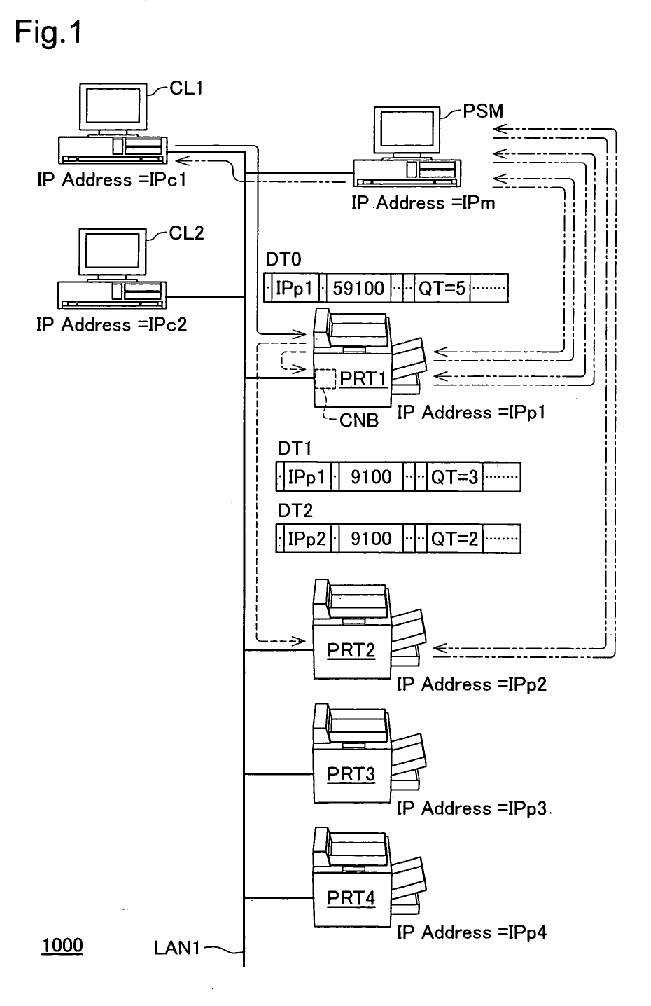

FIG. 1 schematically illustrates the configuration of a distributed printing system 1000 in a first embodiment of the invention. As illustrated in FIG. 1, the distributed printing system 1000 of the first embodiment includes a distributed printing monitor device PSM, multiple client PCs (hereafter simply referred to as clients) CL1 and CL2, and multiple printers PRT1 to PRT4, which are all connected to a local area network LAN1. A fixed IP address is allocated in advance to each of these devices included in the distributed printing system 1000. For the convenience of explanation, it is assumed that an IP address ‘IPm’ is allocated to the distributed printing monitor device PSM, IP addresses ‘IPc1’ and ‘IPc2’ to the clients CL1 and CL2, and IP addresses ‘IPp1’ to ‘IPp4’ to the printers PRT1 to PRT4. These IP addresses are actually set not in the respective devices but on nodes of a TCP/IP network, for example, on network boards.

Among the multiple printers PRT1 to PRT4, the printer PRT1 has a custom network board CNB, which has a distributed printing control function to distribute a received print job to multiple printers specified for distributed printing of the print job. The custom network board CNB is equivalent to the distributed printing control device of the invention. Each of the other printers PRT2 to PRT4 has a standard network board (not shown).

In the illustrated example of FIG. 1, communication data DTO including a print job is sent from the client CL1 to the printer PRT1 as shown by an arrow of the solid line.

The communication data DTO has a header and a print job (print job data). The header includes a receiver IP address and a receiver port number. The receiver IP address is the IP address ‘IPp1’ of the printer PRT1 specified as a receiver of the communication data DTO. The receiver port number is a port number ‘59100’ that identifies a receiver software program installed in the printer PRT1. The print job data includes a QT value ‘5’ representing a total number of required copies as print copy number information.

The distributed printing system 1000 of this embodiment adopts a non-procedural protocol for a print protocol. A port number ‘9100’ is generally allocated in the non-procedural protocol. The distributed printing system 1000 of this embodiment uses the receiver port number ‘59100’, in place of the general port number ‘9100’, in transmission of a print job from one of the clients CL1 and CL2 as a print source device to the printer PRT1 as a distribution source printer having the distributed printing control function.

The custom network board CNB of the printer PRT1 receives the communication data DTO and transfers the print job data included in the received communication data DTO to a software program standing by at the port number ‘59100’. In this embodiment, a distributed printing control software program for attaining the distributed printing control function stands by at the port number ‘59100’. A functional module of a CPU in the printer PRT1 according to the distributed printing control software program retrieves online printers of an identical model with the printer PRT1 among the multiple printers on the local area network LAN1 and specifies distribution destination printers based on the retrieval. For example, the printer PRT2 and the self printer PRT1 are specified as the distribution destination printers. The functional module changes the QT value ‘5’ (5 copies) included in the print job data to new QT values ‘3’ and ‘2’ (3 copies and 2 copies) for distributed printing of the total ‘5 copies’ by the two printers PRT1 and PRT2. The functional module changes the receiver port number from ‘59100’ to ‘9100’ and sends communication data DT1 and DT2 to the printers PRT1 and PRT2 specified as the distribution destination printers as shown by arrows of the broken line.

The communication data DT2 includes ‘IP2’ as the receiver IP address, ‘9100’ as the receiver port number, and ‘2’ as the QT value.

The standard network board attached to the printer PRT2 receives the communication data DT2 and transfers print job data included in the received communication data DT2 to a software program standing by at the port number ‘9100’. The port number ‘9100’ is generally allocated in the non-procedural protocol used for the print protocol as mentioned previously. The print job data is transferred to a print control software program installed in the printer PRT2 and receives an allocated job index. The printer PRT2 then performs printing according to the print job data.

In the same manner, the printer PRT1 having the distributed printing control function, as well as any of the other printers PRT3 and PRT4 performs printing according to received print job data.

The printers PRT1 and PRT2 respectively print ‘3 copies’ and ‘2 copies’. The distributed printing system 1000 accordingly completes distributed printing of the total ‘5 copies’.

The printer PRT1 as the distribution source printer receives print job data as an object of distributed printing (hereafter referred to as distribution print job data) from the client CL1. The functional module of the CPU in the printer PRT1 according to the distributed printing control software program sends divisions of the distribution print job data to the printers PRT1 and PRT2 specified as the distribution destination printers, requests the printers PRT1 and PRT2 to send distribution destination job indexes allocated to the respective divisions of the distribution print job data, and acquires the distribution destination job indexes sent from the printers PRT1 and PRT2 in response to the request. The printer PRT1 as the distribution source printer creates distribution management information for each distribution print job data in the form of an XML file. The distribution management information collectively correlates the IP addresses set in the specified distribution destination printers, the distribution destination job indexes allocated to the respective divisions of the distribution print job data received by the respective distribution destination printers, and the divisional numbers of required copies set in the respective divisions of the distribution print job data received by the respective distribution destination printers, to a distribution source job index allocated to the distribution print job data sent from the client CL1.

The distributed printing monitor device PSM requests the printer PRT1 as the distribution source printer to send the distribution management information created by the printer PRT1 and obtains the distribution management information sent from the printer PRT1 in response to the request as shown by an arrow of the one-dot chain line. The distributed printing monitor device PSM specifies the printers PRT1 and PRT2 as the distribution destinations of the distribution print job data sent from the client CL1, based on the obtained distribution management information. The distributed printing monitor device PSM requests the printers PRT1 and PRT2 specified as the distribution destination printers to send print job-related information, for example, the current status, the name of an object file for printing, the number of required copies, and the number of printed copies, and obtains the print job-related information sent from the printers PRT1 and PRT2 in response to the request as shown by arrows of the two-dot chain line. The distributed printing monitor device PSM refers to the obtained print job-related information and creates print status information representing the status of the distribution print job data, for example, the number of printed copies by each of the specified distribution destination printers and the total number of printed copies by all the specified distribution destination printers. The print status information is sent to the client CL1 as the print source device and informs the user of the current status of the distribution print job data.

### A2. Structures of Printers and Distributed Printing Monitor Device

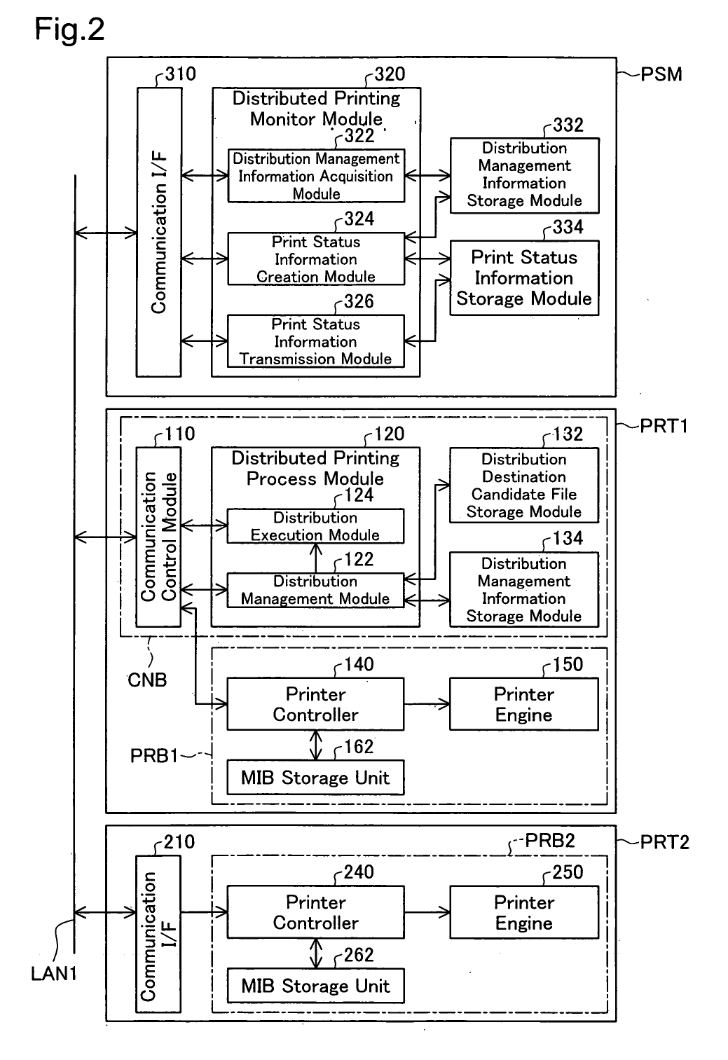

FIG. 2 shows the structures of the printer PRT1 as both the distribution source printer and the distribution destination printer, the printer PRT2 as the distribution destination printer, and the distributed printing monitor device PSM in the distributed printing system 1000 of FIG. 1. The description sequentially regards the structure of the distribution source printer, the structure of the distribution destination printer, and the structure of the distributed printing monitor device with reference to FIG. 2.

### A2.1 Distribution Source Printer

The printer PRT1 as the distribution source printer has a printer main body PRB1 and the custom network board CNB. The printer main body PRB1 mainly includes a printer engine 150, a printer controller 140, and an MIB (management information base) storage unit 162. The printer engine 150 works as an actual printing mechanism. The printer controller 140 receives print job data from the custom network board CNB and controls the printer engine 150 to perform printing according to the received print job data. The printer controller 140 acquires the print job-related information, for example, the current condition of the printer main body PRB1 and the current status of the print job data (for example, completion of printing 1 copy) and sets the acquired print job-related information into an MIB stored in the MIB storage unit 162. The printer controller 140 receives a request from the distributed printing monitor device PSM and sends back MIB values set in management items of the MIB stored in the MIB storage unit 162 to the distributed printing monitor devices PSM. According to a concrete procedure, the distributed printing monitor device PSM sends a preset command defined in SNMP (Simple Network Management Protocol) to the printer PRT1 to request transmission of the print job-related information. The printer controller 140 reads the MIB values out of the MIB stored in the MIB storage unit 162 in response to the transmission request and sends back the MIB values to the distributed printing monitor device PSM.

The custom network board CNB is constructed as a compute system mainly including a CPU and memories like a RAM and a ROM (not shown). The CPU reads and executes the distributed printing control software program and other related software programs stored in the ROM and accordingly functions as the distributed printing control device. Part or all of functional blocks attained by the CPU of the custom network board CNB may alternatively be actualized by the hardware configuration.

The custom network board CNB as the distributed printing control device has a communication control module 110, a distributed printing process module 120 including a distribution management module 122 and a distribution execution module 124, a distribution destination candidate file storage module 132, and a distribution management information storage module 134. The custom network board CNB has other known elements, for example, a physical communication interface for network communication. These elements are omitted for the simplicity of illustration.

The communication control module 110 selects an appropriate communication protocol for each communication counterpart and establishes external communication with the communication counterpart via the local area network LAN1. The communication control module 110 extracts a receiver IP address and a receiver port number included in received communication data and allocates a receiver IP address and a receiver port number to communication data to be sent.

When the received communication data includes print job data as an object of distributed printing, that is, distribution print job data, the distribution management module 122 of the distributed printing process module 120 specifies a distribution destination printer for each division of the distribution print job data among the multiple printers on the local area network LAN1. The distribution destination candidate file storage module 132 stores a distribution destination candidate file that sets candidate printers selected in advance as available distribution destinations for distributed printing among the multiple printers on the local area network LAN1. The distribution management module 122 refers to the distribution destination candidate file stored in the distribution destination candidate file storage module 132 and specifies distribution destination printers among the candidate printers set in the distribution destination candidate file. According to a concrete procedure, the distribution management module 122 sends a preset command defined in SNMP (Simple Network Management Protocol) to each of the candidate printers set in the distribution destination candidate file as an inquiry for printing availability and specifies printing-available printers as the distribution destination printers, based on the replies from the candidate printers to the inquiry. When no such previous selection is required, the distribution destination candidate file storage module 132 has no storage.

The distribution management module 122 creates distribution management information for each received distribution print job data. As described above, the distribution management information correlates the IP addresses as identification information for identifying the specified distribution destination printers and the distribution destination job indexes allocated to the respective divisions of the distribution print job data received by the specified distribution destination printers, to a distribution source job index allocated to the distribution print job data by the distributed printing process module 120 in a receiving order of distribution print job data. The created distribution management information is stored in the distribution management information storage module 134. In response to a transmission request from the distributed printing monitor device PSM, the distribution management module 122 reads the distribution management information from the storage of the distribution management information storage module 134 and sends back the distribution management information to the distributed printing monitor device PSM.

The distribution execution module 124 of the distributed printing process module 120 changes a QT value, which is included in the received distribution print job data and represents a total number of required copies, to a new QT value representing a divisional number of required copies to be printed by each of the specified distribution destination printers, and distributes each division of the distribution print job data to each specified distribution destination printer.

The printer PRT1 functions as both the distribution destination printer and the distribution source printer as mentioned above.

### A2.2 Distribution Destination Printer

The printer PRT2 specified as the distribution destination printer has the similar configuration and functions to those of the printer main body PRB1 of the printer PRT1 described above. The printer PRT2 includes a printer engine 250, a printer controller 240, an MIB storage unit 262, and a standard communication interface (communication I/F) 210 to attain the general communication control functions. The other printers PRT3 and PRT4 specifiable as distribution destination printers have identical configuration and functions to those of the printer PRT2.

### A2.3 Distributed Printing Monitor Device

The distributed printing monitor device PSM is constructed by a general computer system, such as a personal computer (PC), that reads and executes a preset application program stored in a memory (not shown).

The distributed printing monitor device PSM has a communication I/F 310, a distributed printing monitor module 320 including a distribution management information acquisition module 322, a print status information creation module 324, and a print status information transmission module 326, a distribution management information storage module 332, and a print status information storage module 334.

The communication I/F 310 interfaces communication with any of the clients and the printers via the local area network LAN1.

The distribution management information acquisition module 322 of the distributed printing monitor module 320 requests the printer PRT1 as the distribution source printer to send the distribution management information. The distribution management information acquisition module 322 receives the distribution management information read from the storage of the distribution management information storage module 134 in response to the request and sent by the distribution management module 122 of the distributed printing process module 120 in the printer PRT1.

The print status information creation module 324 of the distributed printing monitor module 320 sends a preset command defined in SNMP to each distribution destination printer identified by the identification information of the distribution destination printers included in the distribution management information and requests each identified distribution destination printer to send the print job-related information set in the MIB in the identified distribution destination printer. The print status information creation module 324 acquires the print job-related information sent back from each distribution destination printer in response to the preset command, creates print status information representing the print status of the distribution print job data by the distribution destination printer, and stores the print status information into the print status information storage module 334.

The print status information transmission module 326 of the distributed printing monitor module 320 sends the created print status information to the client as the print source device that has sent the distribution print job data, that is, the client identified by the identification information of the print source device included in the distribution management information. The print status information transmission module 326 may be actualized, for example, by a general messenger.

The print status information sent to the client informs the user of the current status of the distribution print job data.

### A3. Distributed Printing Process

The description regards a distributed printing process executed by the distribution source printer, which receives print job data as an object of distributed printing, that is, distribution print job data, from the client as the print source device.

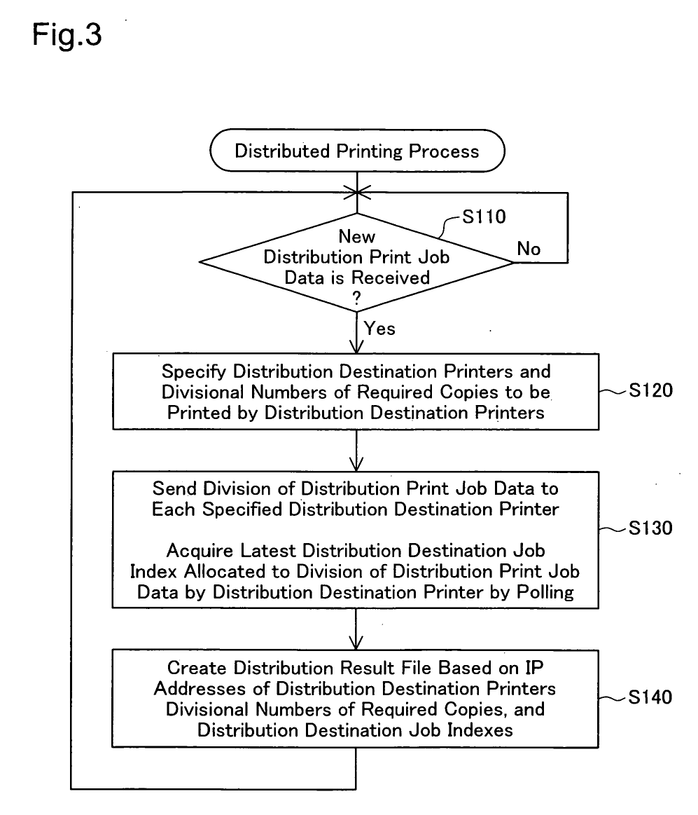

In the printer PRT1 as the destination source printer, the distributed printing process module 120 executes a distributed printing process in response to reception of each distribution print job data. FIG. 3 is a flowchart showing the distributed printing process executed repeatedly by the distributed printing process module 120.

The CPU of the custom network board CNB in the printer PRT1 reads and executes the application program stored in the preset memory to function as the distributed printing process module 120 and attain the distributed printing process.

The distributed printing process module 120 waits until reception of new distribution print job data (step S110).

In response to reception of new distribution print job data (step S110: Yes), the distribution management module 122 of the distributed printing process module 120 specifies distribution destination printers and divisional numbers of required copies to be printed by the respective distribution destination printers (step S120).

The distribution execution module 124 of the distributed printing process module 120 delivers divisions of the distribution print job data with the divisional numbers of required copies to the specified distribution destination printers. During transmission of the respective divisions of the distribution print job data by the distribution execution module 124, the distribution management module 122 sends a preset command defined in SNMP to each of the specified distribution destination printers and obtains a latest distribution destination job index allocated to each division of the distribution print job data by the distribution destination printer (step S130). The distribution management module 122 creates a distribution result file, based on the IP addresses of the specified distribution destination printers, the divisional numbers of required copies to be printed by the respective distribution destination printers, and the distribution destination job indexes allocated to the respective divisions of the distribution print job data by the respective distribution destination printers (step S140).

The processing of steps S110 to S140 is repeated in response to reception of new distribution print job data at step S110. A distribution result file is created for each received distribution print job data (distribution print job).

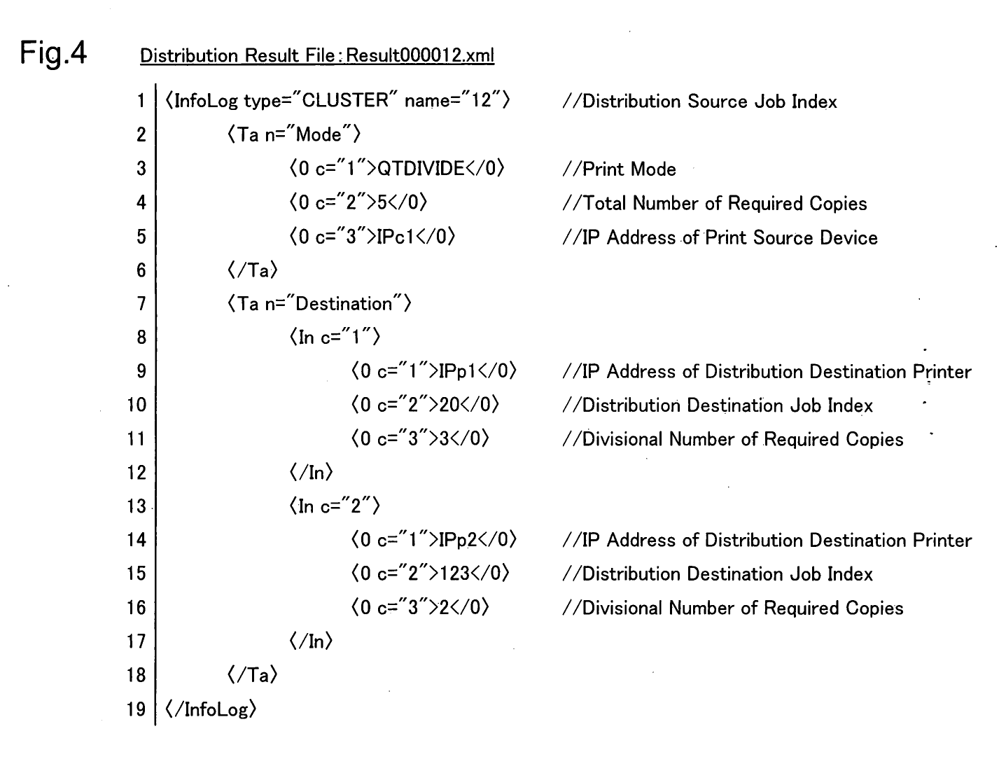

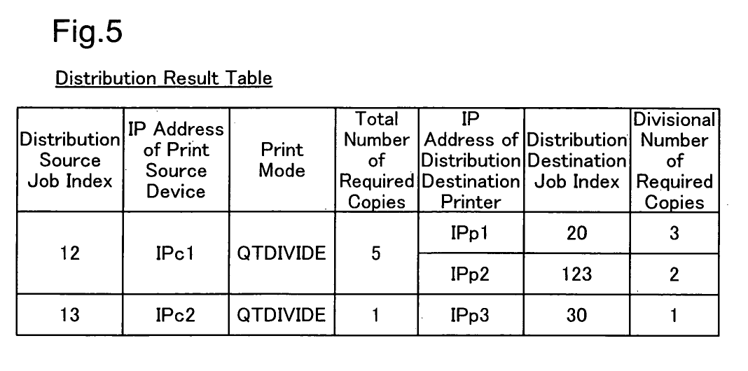

FIG. 4 shows one example of the distribution result file. FIG. 5 is a distribution result table showing distribution management information specified by the distribution result file of FIG. 4. The distribution result file of FIG. 4 is an XML file under a file name of ‘Result000012.xml’ opened by an editor. The file name ‘000012’ represents a distribution source job index allocated to received distribution print job data by the distributed printing process module 120 in a receiving order of distribution print job data.

The description on the 1^{st} line shows a distribution source job index exclusively and sequentially allocated to each received distribution print job data by the printer PRT1 as the distribution source printer in a receiving order of the distribution print job data. In the illustrated example of FIG. 4, the allocated distribution source job index is ‘12’. This means that the distribution management information specified by the distribution result file regards the distribution print job data with the allocated distribution source job index ‘12’.

The description of the 2^{nd} line to the 6^{th} line shows information on the received distribution print job data, that is, a print mode, a total number of required copies, and an IP address as identification information of the client as the print source device. The description on the 3^{rd} line represents information of the print mode: ‘QTDIVIDE’ representing copies distributed printing and ‘QTCOPY’ representing duplicate distributed printing. In the illustrated example of FIG. 4, the print mode ‘QTDIVIDE’ represents the copies distributed printing. The description on the 4^{th} line represents information on the total number of required copies. In the illustrated example of FIG. 4, the total number of required copies is ‘5 copies’. The description on the 5^{th} line represents an IP address as identification information of the client as the print source device. In the illustrated example of FIG. 4, the IP address ‘IPc1’ identifies the client CL1 as the print source device.

The description of the 7^{th} line to the 18^{th} line shows information regarding the respective distribution destination printers, that is, IP addresses as identification information of the distribution destination printers, distribution destination job indexes allocated to respective divisions of the distribution print job data received by the respective distribution destination printers, and divisional numbers of required copies. The description of the 8^{th} line to the 12^{th} line represents information on a first distribution destination printer, and the description of the 13^{th} line to the 17^{th} line represents information on a second distribution destination printer.

Among the description of the 8^{th} line to the 12^{th} line, the description on the 9^{th} line represents an IP address as identification information of a distribution destination printer. In the illustrated example of FIG. 4, the IP address ‘IPp1’ identifies the printer PRT1 as the first distribution destination printer. The description on the 10^{th} line represents a distribution destination job index allocated to the division of the distribution print job data received by the distribution destination printer specified by the description on the 9^{th} line. In the illustrated example of FIG. 4, the distribution destination job index allocated to the division of the distribution print job data is ‘20’. The description on the 11^{th} line represents a divisional number of required copies included in the division of the distribution print job data corresponding to the distribution destination job index specified by the description on the 10^{th} line. In the illustrated example of FIG. 4, the divisional number of required copies is ‘3 copies’.

The description of the 13^{th} line to the 17^{th} line is similar to the description of the 8^{th} line to the 12^{th} line. The description on the 14^{th} line represents an IP address as identification information of a distribution destination printer. In the illustrated example of FIG. 4, the IP address ‘IPp2’ identifies the printer PRT2 as the second distribution destination printer. The description on the 15^{th} line represents a distribution destination job index allocated to the division of the distribution print job data received by the distribution destination printer specified by the description on the 14^{th} line. In the illustrated example of FIG. 4, the distribution destination job index allocated to the division of the distribution print job data is ‘123’. The description on the 16^{th} line represents a divisional number of required copies included in the division of the distribution print job data corresponding to the distribution destination job index specified by the description on the 15^{th} line. In the illustrated example of FIG. 4, the divisional number of required copies is ‘2 copies’.

The description of the distribution result file shown in FIG. 4 regards the case of specifying two printers as the distribution destination printers. When three or more printers are specified as the distribution destination printers, the similar description to the description of the 8^{th} line to the 12^{th} line is repeated for each additional distribution destination printer between the 17^{th} line and the 18^{th} line.

In both the distribution result file of FIG. 4 and the distribution result table of FIG. 5, the IP address of the print source device, the print mode, the total number of required copies, the IP addresses of the specified distribution destination printers, the distribution destination job indexes for identifying the respective divisions of the distribution print job data received by the specified distribution destination printers, and the divisional numbers of required copies to be printed by the specified distribution destination printers are correlated to each distribution source job index. The distribution result table of FIG. 5 includes information equivalent to the distribution result file of FIG. 4 with the distribution source job index ‘12’ and information equivalent to a distribution result file with a distribution source job index ‘13’.

### A4. Distributed Printing Monitor Process

The description regards the distributed printing monitor process executed by the distributed printing monitor device PSM. In the distributed printing monitor device PSM, the distributed printing monitor module 320 executes a distribution management information acquisition process and a print status monitor process as two series of distributed printing monitor process.

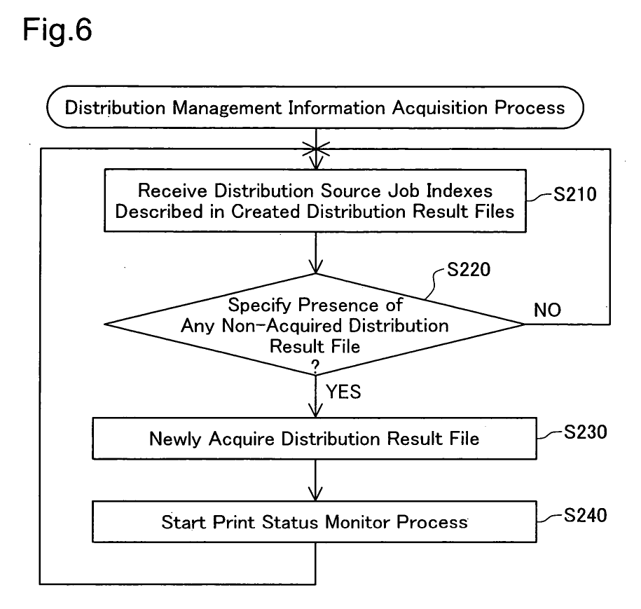

FIG. 6 is a flowchart showing the distribution management information acquisition process executed by the distributed printing monitor module 320.

The CPU of the distributed printing monitor device PSM reads and executes the application program stored in the preset memory to function as the distribution management information acquisition module 322 and the print status information creation module 324 of the distributed printing monitor module 320 and attain the distribution management information acquisition process and the print status monitor process.

In the distribution management information acquisition process, the distribution management information acquisition module 322 first sends a preset transmission command defined in SNMP to the printer PRT1 as the distribution source printer, and receives distribution source job indexes described in distribution result files created by the printer PRT1, in response to the preset transmission command (step S210). The distribution management information acquisition module 322 then specifies the presence or the absence of any non-acquired distribution result file (step S220).

In the presence of any non-acquired distribution result file (step S220: Yes), the distribution management information acquisition module 322 gives a distribution result file-sending request to the printer PRT1 as the distribution source printer and acquires a distribution result file newly sent from the printer PRT1 in response to the request (step S230). The newly acquired distribution result file is stored in the distribution management information storage module 332. The print status information creation module 324 then starts monitoring the print status of distribution print job data with regard to the newly acquired distribution result file (step S240). The distribution management information acquisition process then returns to step S210 to monitor the occurrence of any non-acquired distribution result file.

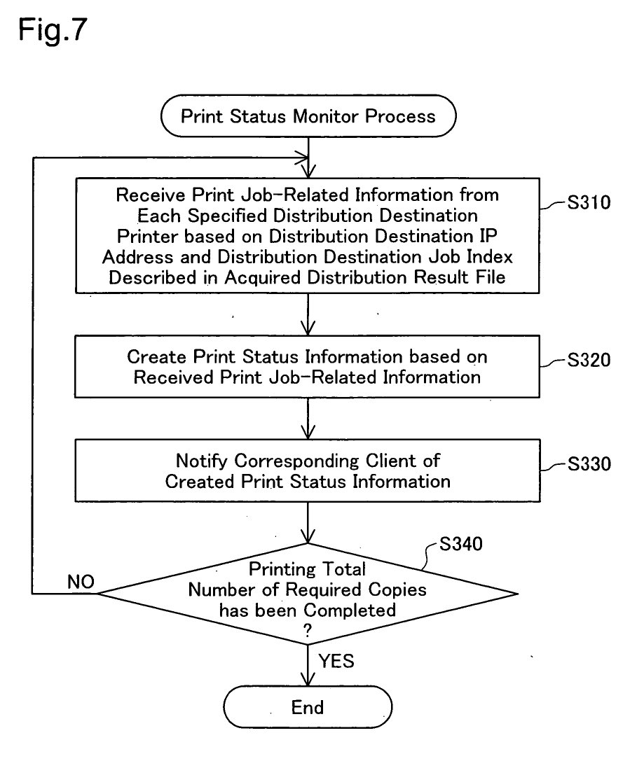

FIG. 7 is a flowchart showing the print status monitor process executed by the distributed printing monitor module 320.

In the print status monitor process, the print status information creation module 324 first extracts the distribution destination IP address and the distribution destination job index of each specified distribution destination printer from the description in the acquired distribution result file, sends a preset transmission command defined in SNMP to the specified distribution destination printer, and receives print job-related information corresponding to the extracted distribution destination job index of the specified distribution destination printer, in response to the preset transmission command (step S310). The print status information creation module 324 then creates print status information, based on the received print-job related information (step S320). The created print status information is stored in the print status information storage module 334.

The print status information transmission module 326 sends the print status information created and stored by the print status information creation module 324 to the client CL1 as the print source device that has originally sent the distribution print job data corresponding to the created print status information (step S330).

The print status monitor process of steps S310 to S330 is repeated until completion of printing the total number of required copies (step S340: Yes).

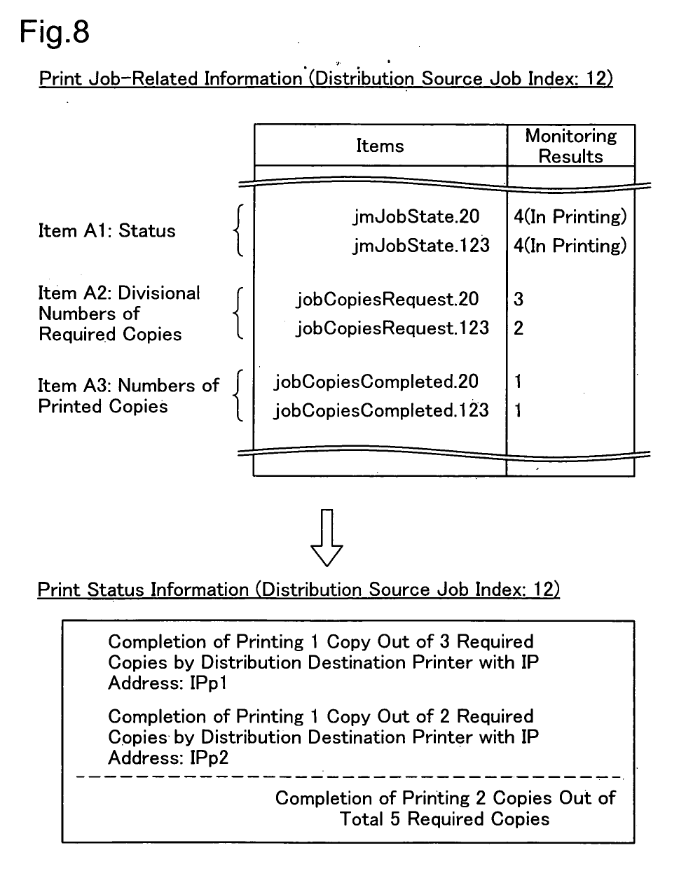

FIG. 8 shows one example of print status information created based on print job-related information received from distribution destination printers. The upper half of FIG. 8 shows print job-related information received from distribution destination printers that are executing a distribution print job identified by a distribution source job index ‘12’. The lower half of FIG. 8 shows print status information created based on the print job-related information.

In the print job-related information shown in the upper half of FIG. 8, a left column and a right column respectively show various items and information regarding the receiving results with regard to the respective items. An item A1 represents the current status of each division of the distribution print job in each distribution destination printer (jmJobState). An item A2 represents the divisional number of required copies (QT value) set in each division of the distribution print job (jobCopiesRequest). An itme A3 represents the number of printed copies by each distribution destination printer (jobCopiesCompleted). Each numeral given as suffixes of the respective items is a distribution destination job index allocated to each division of distribution print job delivered to each distribution destination printer. The example of FIG. 8 shows the print job-related information with regard to the distribution source job index ‘12’, which is correlated to the printers PRT1 and PRT2 as the distribution destination printers as shown in FIG. 4. The numerals given as the suffices of the respective items are a distribution destination job index ‘20’ allocated to a division of the distribution print job delivered to the printer PRT1 and a distribution destination job index ‘123’ allocated to a division of the distribution print job delivered to the printer PRT2.

The print status information in the lower half of FIG. 8 is created, based on the distribution result file of FIG. 4 and the print job-related information in the upper half of FIG. 8. The created print status information of FIG. 8 shows ‘completion of printing 1 copy out of 3 required copies by distribution destination printer with IP address: IPp1’, ‘completion of printing 1 copy out of 2 required copies by distribution destination printer with IP address: IPp2’, and ‘completion of printing 2 copies out of total 5 required copies’.

The print status monitor process is executed for newly acquired each distribution result file, that is, for each distribution print job data (distribution print job) sent to the distribution source printer PRT1.

### A5. Effects of Embodiment

As described above, the printer PRT1 as the distribution source printer receives each distribution print job data (distribution print job) from the client and creates distribution management information for the distribution print job data as a distribution result file. The distribution management information collectively correlates the IP addresses set in the specified distribution destination printers, the distribution destination job indexes allocated to the respective divisions of the distribution print job data received by the respective distribution destination printers, the divisional numbers of required copies set in the respective divisions of the distribution print job data, and the IP address of the client as the print source device sending the distribution print job data, to the distribution source job index allocated to the distribution print job data.

The distributed printing monitor device PSM acquires a distribution result file created for each distribution print job data by the printer PRT1, specifies the distribution destination printers receiving the respective divisions of the distribution print job data from the acquired distribution result file, receives print job-related information from each specified distribution destination printer, and creates print status information based on the received print job-related information. The created print status information is sent to the client as the print source device that has sent the distribution print job data.

Even when the user is not informed of specification of printers as distribution destinations of distribution print job data (distribution print job), this arrangement enables the user to monitor the print status of the respective divisions of the distribution print job data executed by the specified distribution destination printers.

### B. Second Embodiment

### B1. System Configuration

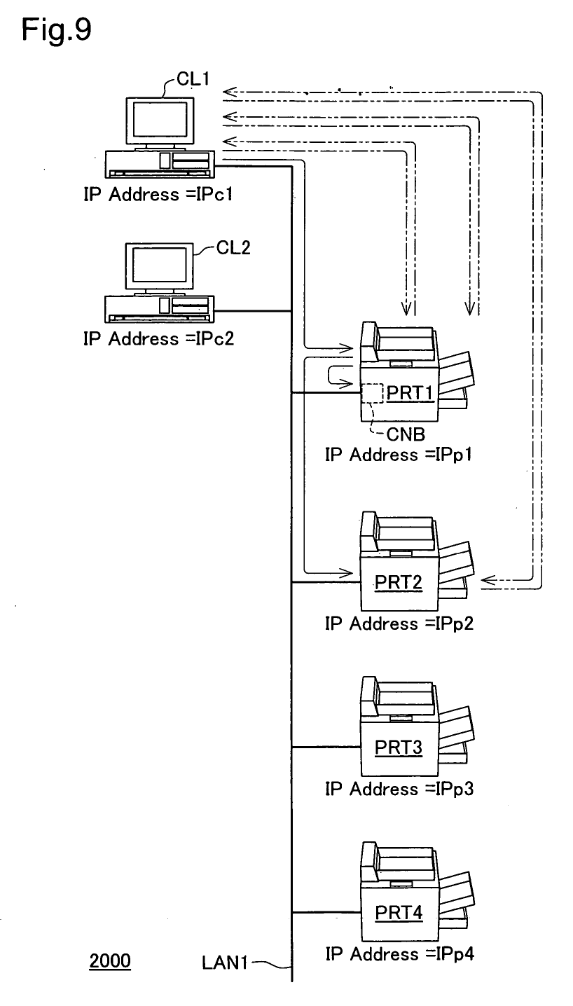

FIG. 9 schematically illustrates the configuration of a distributed printing system 2000 in a second embodiment of the invention. The distributed printing system 2000 of the second embodiment omits the distributed printing monitor device PSM from the distributed printing system 1000 of the first embodiment and gives the functions of the distributed printing monitor device to each client as a print source device. The functions of the distributed printing monitor device included in each client are essentially similar to those of the distributed printing monitor device PSM, except some modifications. The client monitors the print status of each distribution print job sent by the client itself and displays the result of monitoring on the client itself.

### B2. Structures of Printers and Distributed Printing Monitor Device

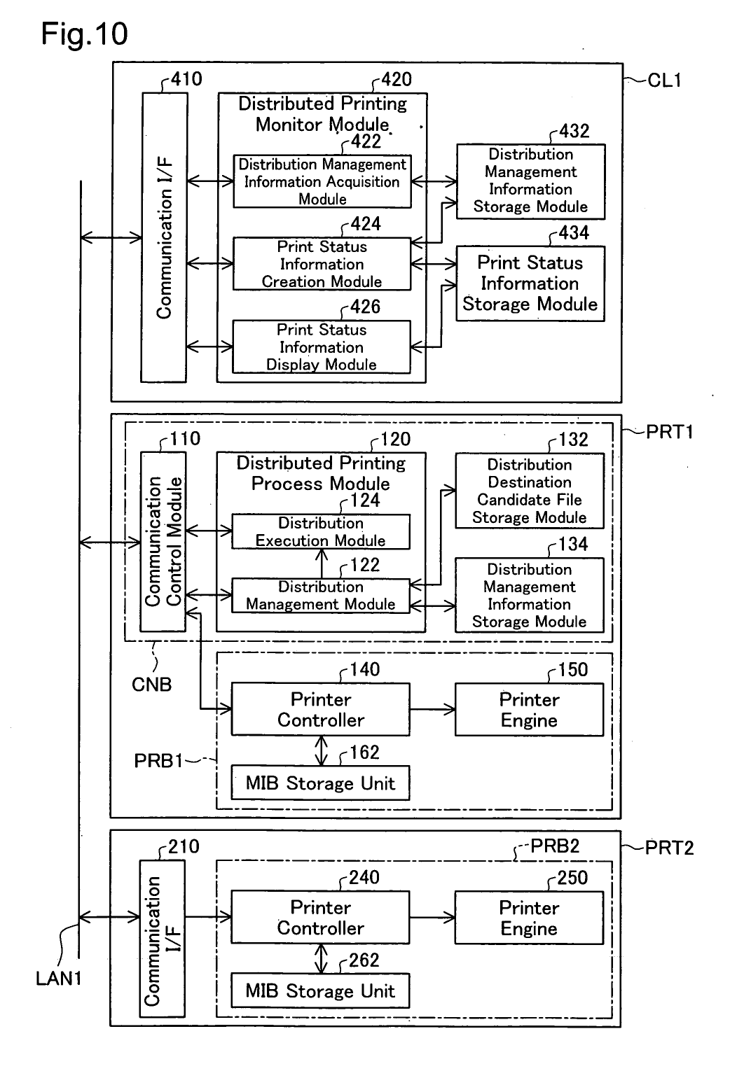

FIG. 10 shows the structures of a printer PRT1 as both a distribution source printer and a distribution destination printer, a printer PRT2 as the distribution destination printer, and a client CL1 having the functions of a distributed printing monitor device in the distributed printing system 2000 of FIG. 9. The structures of the printers PRT1 and PRT2 in the distributed printing system 2000 of the second embodiment are identical with the structures of the printers PRT1 and PRT2 in the distributed printing system 1000 of the first embodiment and are thus not specifically described here. Only the structure of the client CL1 having the functions of the distributed printing monitor device is discussed below.

The client CL1 reads and executes a preset application program stored in a memory (not shown) to function as the distributed printing monitor device.

The client CL1 as the distributed printing monitor device has a communication I/F 410, a distributed printing monitor module 420 including a distribution management information acquisition module 422, a print status information creation module 424, and a print status information display module 426, a distribution management information storage module 432, and a print status information storage module 434.

The communication I/F 410 and the distribution management information acquisition module 422 and the print status information creation module 424 of the distributed printing monitor module 420 in the client CL1 of the second embodiment are functional blocks having the identical functions with those of the communication I/F 310 and the distribution management information acquisition module 322 and the print status information creation module 324 of the distributed printing monitor module 320 in the distributed printing monitor device PSM of the first embodiment, and are thus not specifically described here.

The print status information display module 426 of the distributed printing monitor module 420 displays the print status information stored in the print status information storage module 434 and informs the user of the print status of respective divisions of distribution print job data.

The client CL2 has the same structure as that of the client CL1 described above.

### B3. Distributed Printing Monitor Process

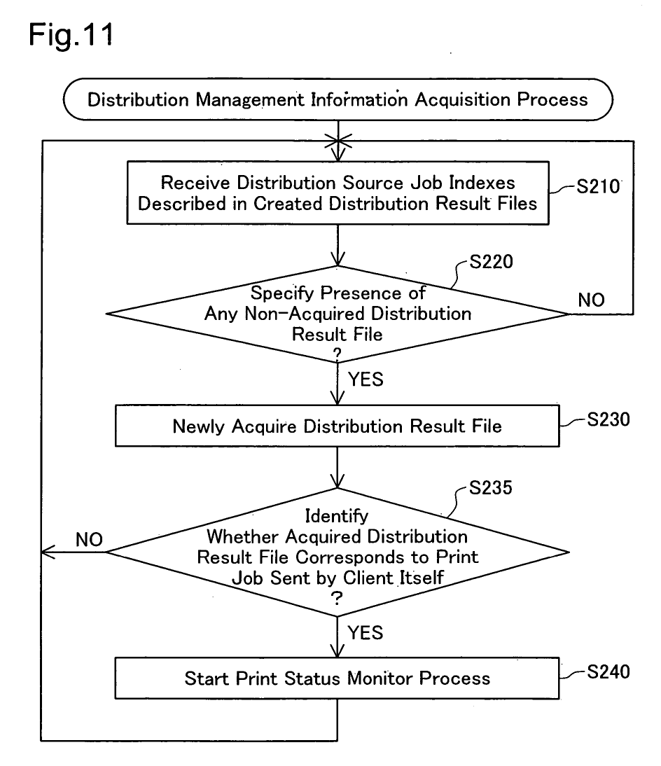

FIG. 11 is a flowchart showing a distribution management information acquisition process executed by the distributed printing monitor module 420 included in the client CL1. The distribution management information acquisition process of the second embodiment executed by the distribution management information acquisition module 422 and the print status information creation module 424 of the distributed printing monitor module 420 has an additional step S235 between steps S230 and S240 in the distribution management information acquisition process of the first embodiment (see FIG. 6) executed by the distribution management information acquisition module 322 and the print status information creation module 324 of the distributed printing monitor module 320.

The distribution management information acquisition module 422 acquires a distribution result file newly sent from the printer PRT1 (step S230) and identifies whether the newly acquired distribution result file is a distribution result file corresponding to the distribution print job data sent by the client CL1 itself (step S235). The identification is based on the IP address of the print source device written in the acquired distribution result file.

When the acquired distribution result file corresponds to the distribution print job data sent by the client CL1 as the print source device (step S235: Yes), the print status information creation module 424 starts monitoring the print status of the distribution print job data with regard to the newly acquired distribution result file (step S240). The distribution management information acquisition process then returns to step S210 to monitor the occurrence of any non-acquired distribution result file. When the acquired distribution result file does not correspond to the distribution print job data sent by the client CL1 as the print source device (step S235: No), on the other hand, the distribution management information acquisition process immediately returns to step S210 to monitor the occurrence of any non-acquired distribution result file.

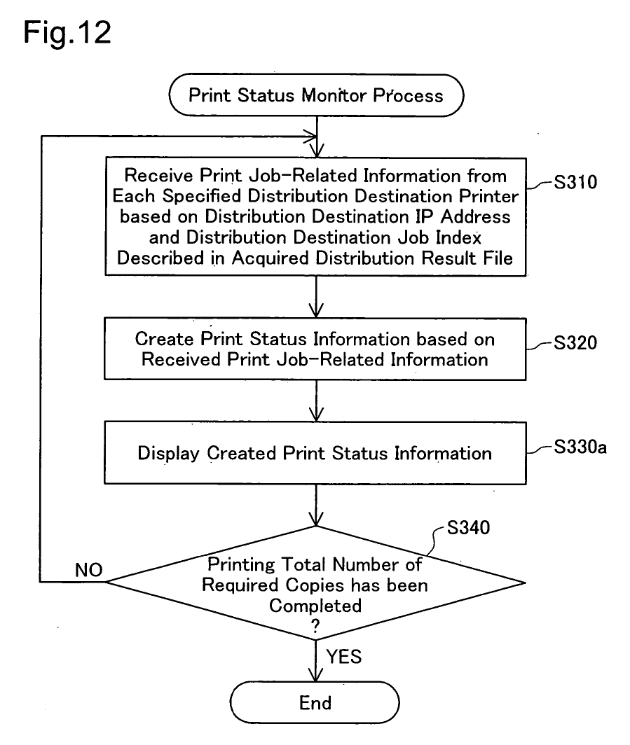

FIG. 12 is a flowchart showing a print status monitor process executed by the distributed printing monitor module 420. The print status monitor process of the second embodiment executed by the print status information creation module 424 and the print status information display module 426 of the distributed printing monitor module 420 includes an alternative step S330a, in place of step S330 in the print status monitor process of the first embodiment (see FIG. 7) executed by the print status information creation module 324 and the print status information transmission module 326 of the distributed printing monitor module 320.

In the print status monitor process of the first embodiment, the print status information transmission module 326 sends the created print status information to the client CL1 as the print source device that has originally sent the distribution print job data corresponding to the created print status information at step S330. In the configuration of the second embodiment, the client CL1 that has sent the distribution print job data is executing this print status monitor process. In the print status monitor process of the second embodiment, the print status information display module 426 displays the created print status information on the client CL1 at step S330a.

### B4. Effects of Embodiment

Even when the user is not informed of specification of printers as distribution destinations of distribution print job data (distribution print job), this arrangement enables the user to monitor the print status of the respective divisions of the distribution print job data executed by the specified distribution destination printers. In the second embodiment, each client has the functions of the distributed printing monitor device. The configuration of the second embodiment thus advantageously has no requirement for construction of a separate distributed printing monitor device, which is independently provided on the network in the configuration of the first embodiment. The advantage of the configuration of the first embodiment, on the contrary, has no requirement for adding the functions of the distributed printing monitor device to the client.

### C. Third Embodiment

### C1. System Configuration

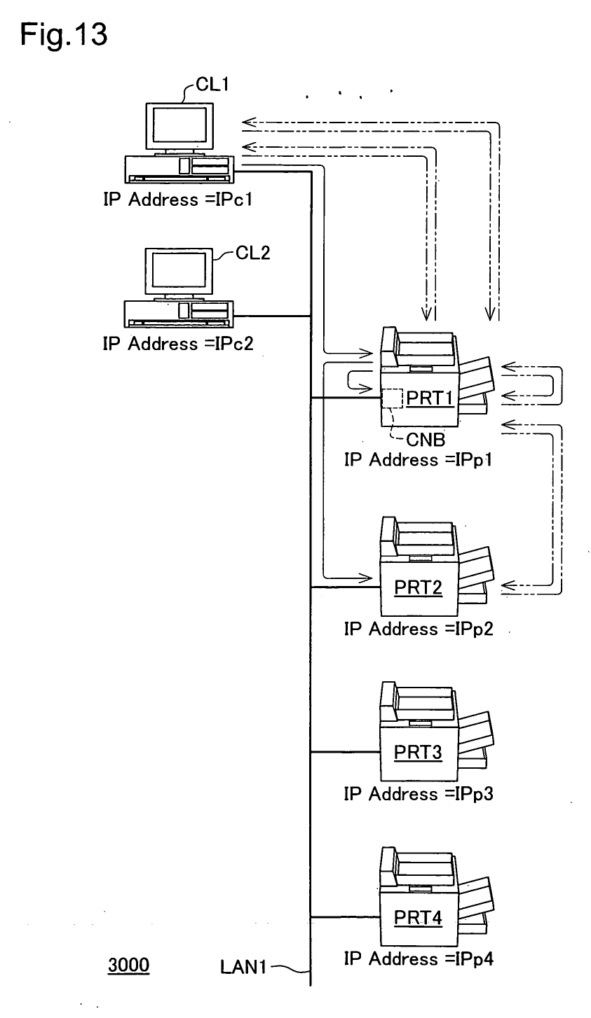

FIG. 13 schematically illustrates the configuration of a distributed printing system 3000 in a third embodiment of the invention. The distributed printing system 3000 of the third embodiment omits the distributed printing monitor device PSM from the distributed printing system 1000 of the first embodiment and gives the functions of the distributed printing monitor device partly to each of clients CL1 and CL2 as a print source device and partly to a printer PRT1 as a distribution source printer. In the distributed printing system 3000 of the third embodiment, in response to a transmission request of print status information from the client CL1 to the printer PRT1, the printer PRT1 sends a transmission request to each of specified distribution destination printers, receives print job-related information from each distribution destination printer, creates print status information based on the received print job-related information, and sends the created print status information to the client CL1 (shown by arrows of the two-dot chain line). The client CL1 is thus notified of the print status of a distribution print job by each of the specified distribution destination printers.

The client CL2 has the same structure as that of the client CL1 described above.

### C2. Structures of Printers and Distributed Printing Monitor Device

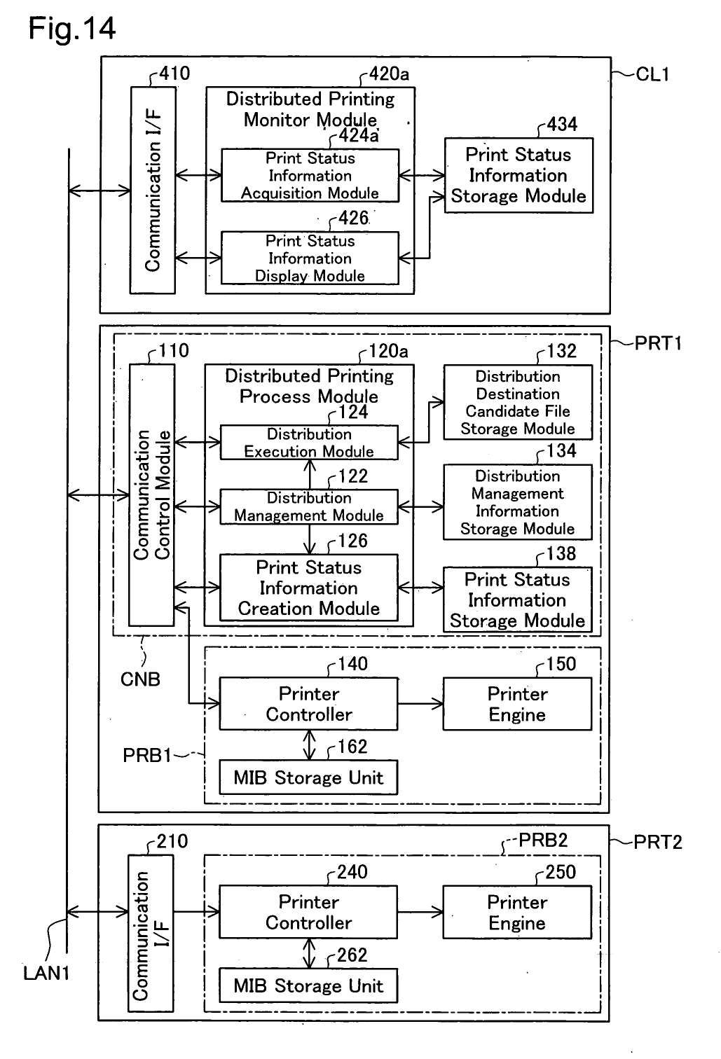

FIG. 14 shows the structures of a printer PRT1 as a distribution source printer having part of the functions of a distributed printing monitor device, a printer PRT2 as a distribution destination printer, and a client CL1 having a residual part of the functions of the distributed printing monitor device in the distributed printing system 3000 of FIG. 13. The structure of the printer PRT2 in the distributed printing system 3000 of the third embodiment is identical with the structure of the printer PRT2 in the distributed printing system 1000 of the first embodiment and is thus not specifically described here. Only the structures of the client CL1 and the printer PRT1 are discussed below.

The printer PRT1 of the third embodiment has a distributed printing process module 120a, in place of the distributed printing process module 120 (see FIG. 2) in the printer PRT1 of the first embodiment. The distributed printing process module 120a has a print status information creation module 126, in addition to the distribution management module 122 and the distribution execution module 124. The print status information creation module 126 has the equivalent functions to those of the print status information creation module 324 of the distributed printing monitor module 320 in the distributed printing monitor device PSM of the first embodiment. The printer PRT1 of the third embodiment additionally has a print status information storage module 136 in combination with the presence of the print status information creation module 126. The print status information storage module 136 has the equivalent functions to those of the print status information storage module 334 included in the distributed printing monitor device PSM of the first embodiment.

The print status information creation module 126 sends a preset command defined in SNMP to each distribution destination printer identified by the identification information of the distribution destination printers included in the distribution management information and requests each identified distribution destination printer to send the print job-related information set in the MIB in the identified distribution destination printer. The print status information creation module 126 acquires the print job-related information sent back from each distribution destination printer in response to the preset command, creates print status information representing the print status of the distribution print job data by the distribution destination printer, and stores the print status information into the print status information storage module 136.

The client CL1 reads and executes a preset application program stored in a memory (not shown) to function as the distributed printing monitor device.

The client CL1 as the distributed printing monitor device has a communication I/F 410, a distributed printing monitor module 420a including a print status information acquisition module 424a and a print status information display module 426, and a print status information storage module 434.

The communication I/F 410, the print status information display module 426 of the distributed printing monitor module 420a, and the print status information storage module 434 in the client CL1 of the third embodiment are functional blocks having the identical functions with those of the corresponding constituents in the client CL1 of the second embodiment and are thus not specifically described here.

The print status information acquisition module 424a of the distributed printing monitor module 420a requests the print status information creation module 126 to send the print status information created by the print status information creation module 126 and stored in the print status information storage module 136 of the printer PRT1, and stores the acquired print status information into the print status information storage module 434.

### C3. Distributed Printing Monitor Process

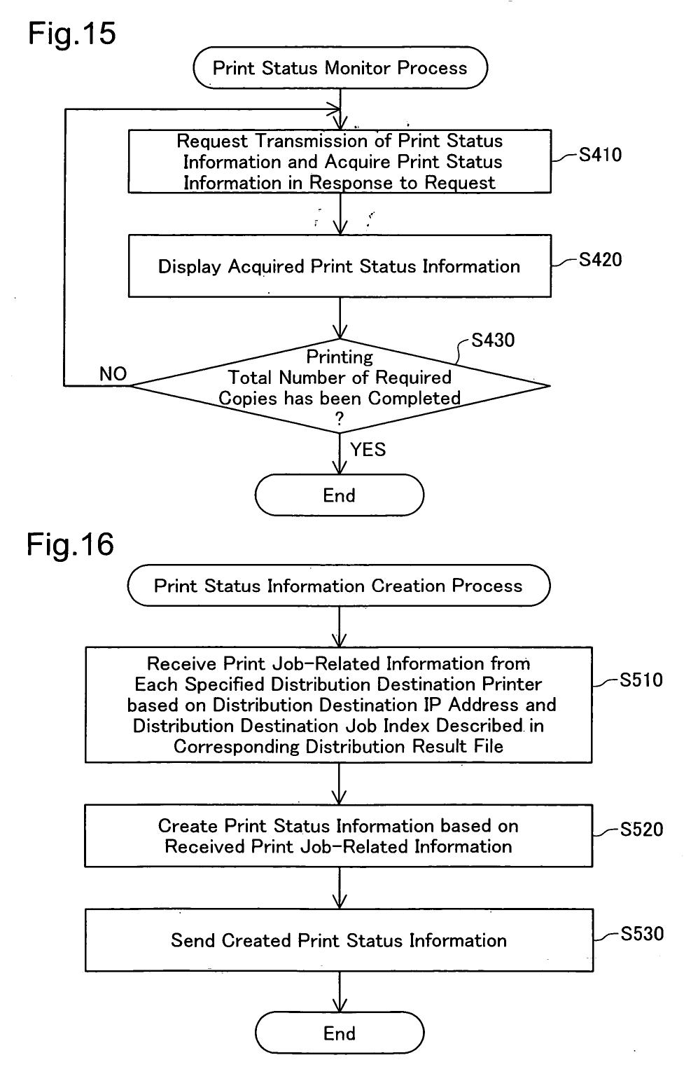

FIG. 15 is a flowchart showing a print status monitor process executed by the distributed printing monitor module 420a. The distributed printing monitor module 420a starts the print status monitor process in response to transmission of distribution print job data from the client CL1 as the print source device. The print status information acquisition module 424a of the distributed printing monitor module 420a requests the print status information creation module 126 of the printer PRT1 to send print status information and acquires the print status information in response to the request (step S410). The print status information creation module 126 of the distributed printing process module 120a included in the printer PRT1 executes a print status information creation process described below and sends the created print status information to the print status information acquisition module 424a of the distributed printing monitor module 420a in response to the transmission request. The print status information display module 426 of the distributed printing monitor module 420a displays the acquired print status information (step S420). The print status monitor process of steps S410 and S420 is repeated until completion of printing the total number of required copies (step S430: Yes).

FIG. 16 is a flowchart showing a print status information creation process executed by the print status information creation module 126 of the distributed printing process module 120a. In response to the transmission request of the print status information from the print status information acquisition module 424a of the distributed printing monitor module 420a included in the client CL1, the print status information creation module 126 of the distributed printing process module 120a included in the printer PRT1 starts the print status information creation module. The print status information creation module 126 first extracts the distribution destination IP address and the distribution destination job index of each specified distribution destination printer from the description in a distribution result file corresponding to a print job sent from the client CL1 as the print source device, sends a preset transmission command defined in SNMP to the specified distribution destination printer, and receives print job-related information corresponding to the extracted distribution destination job index of the specified distribution destination printer, in response to the preset transmission command (step S510). The print status information creation module 126 creates the print status information based on the received print job-related information (step S520) and sends the created print status information as a reply to the transmission request to the client CL1 (step S530).

### C4. Effects of Embodiment

Even when the user is not informed of specification of printers as distribution destinations of a print job, this arrangement enables the user to readily specify the distribution destination printers and monitor the print status of the respective divisions of the print job delivered to the specified distribution destination printers. Like the second embodiment, the configuration of the third embodiment advantageously has no requirement for construction of a separate distributed printing monitor device, which is independently provided on the network in the configuration of the first embodiment.

### D. Modifications

The embodiments and their applications or modifications discussed above are to be considered in all aspects as illustrative and not restrictive. There may be many other modifications, changes, and alterations without departing from the scope or spirit of the main characteristics of the present invention. Some examples of possible modification are given below.

### D1. MODIFIED EXAMPLE 1

In the embodiments discussed above, distribution management information is created for each distribution print job in the form of a distribution result file. Multiple sets of distribution management information for multiple distribution print jobs may be summarized in one data file as a distribution result table.

### D2. MODIFIED EXAMPLE 2

The embodiments discussed above use the IP addresses as the identification information of the print source device, the distribution source printer, and the distribution destination printers. The IP addresses may be replaced by any of other suitable identification information, for example, the names of the respective devices or printers or MAC (Media Access Control) addresses.

### D3. MODIFIED EXAMPLE 3

In the embodiments discussed above, the distributed printing control device is constructed as the custom network board CNB incorporated in the printer PRT1. The technique of the invention is, however, not restricted to this structure. A distributed printing control device may be constructed separately from the printer PRT1 and may be connected to the printer PRT1 by wired connection, such as USB connection, IEEE1394 connection, parallel connection, or serial connection or by wireless connection, such as Bluetooth connection, wireless LAN connection, or IR connection. A server constructed separately from the printer PRT1 and connected to the local area network LAN1 may be used as the distributed printing control device.

Finally the present application claims the priority based on Japanese Patent Application No. 2005-097334 filed on Mar. 30, 2005, which is herein incorporated by reference.

What is claimed is:

1. A distributed printing control device that distributes each distribution print job for distributed printing, which is received from a print source device via a network, to one or multiple distribution destination printing devices selected as distribution destinations of the distribution print job among plural printing devices on the network, the distributed printing control device comprising:
a distribution management module that receives a distribution print job, specifies one or multiple distribution destination printing devices, and creates distribution management information, where the distribution management information correlates distribution destination identification information of each specified distribution destination printing device and a distribution destination job index allocated to each division of the distribution print job by the specified distribution destination printing device, to a distribution source job index allocated to the distribution print job in a receiving order of the distribution print job; and
a distribution execution module that distributes the distribution print job to the one or multiple specified distribution destination printing devices.

2. A distributed printing control device in accordance with claim 1, wherein the distribution management module stores the created distribution management information and, in response to a transmission request of the distribution management information from a distributed printing monitor device on the network, sends the stored distribution management information to the distributed printing monitor device.

3. A distributed printing control device in accordance with claim 1, the distributed printing control device further comprising:
a print status information creation module that receives from the print source device a transmission request of print status information representing a print status of each division of the distribution print job in each distribution destination printing device, extracts the distribution destination identification information of each specified distribution destination printing device from the distribution management information, acquires print job-related information regarding the distribution print job from the distribution destination printing device identified by the extracted distribution destination identification information, creates the print status information based on the acquired print job-related information, and sends the created print status information to the print source device.

4. A distributed printing control device in accordance with claim 1, wherein the distribution source job index is an exclusive index number sequentially allocated to each distribution print job in its receiving order.

5. A distributed printing control device in accordance with claim 1, the distributed printing control device being incorporated or connected to at least one specific printing device among the plural printing devices on the network.

6. A printing device that comprises a distributed printing control device in accordance with claim 1.

7. A distributed printing monitor device that monitors a print status of each division of a distribution print job for distributed printing, which is sent via a network from a print source device to a distributed printing control device on the network, where the distributed printing control device specifies one or multiple distribution destination printing devices as distribution destinations of the distribution print job among plural printing devices on the network and distributes the distribution print job to the one or multiple specified distribution destination printing devices, the distributed printing monitor device comprising:
a distribution management information acquisition module that acquires distribution management information created by and sent from the distributed printing control device, where the distribution management information correlates distribution destination identification information of each specified distribution destination printing device and a distribution destination job index allocated to each division of the distribution print job by the specified distribution destination printing device, to a distribution source job index allocated to the distribution print job in a receiving order of distribution print jobs; and
a print status information creation module that extracts the distribution destination identification information of each specified distribution destination printing device, which receives each division of the distribution print job, from the acquired distribution management information, receives print job-related information regarding the distribution print job from the distribution destination printing device identified by the extracted distribution destination identification information, and creates print status information representing a print status of each division of the distribution print job in each distribution destination printing device, based on the received print job-related information.

8. A distributed printing monitor device in accordance with claim 7, the distributed printing monitor device further comprising:
a print status information transmission module that sends the created print status information to the print source device.

9. A distributed printing monitor device in accordance with claim 7, the distributed printing monitor device being incorporated in the print source device, the distributed printing monitor device further comprising:
a print status information display module that displays the created print status information.

10. A distributed printing monitor system including plural printing devices, a distributed printing control device, and a distributed printing monitor device that are interconnected via a network, wherein the distributed printing control device distributes a distribution print job for distributed printing, which is received from the print source device via the network, to one or multiple distribution destination printing devices selected as distribution destinations of the distribution print job among the plural printing devices on the network, and the print source device is notified of a print status of each division of the distribution print job in each specified distribution destination printing device,
the distributed printing control device receiving the distribution print job, specifying one or multiple distribution destination printing devices, distributing the distribution print job to the one or multiple specified distribution destination printing devices, and creating distribution management information, where the distribution management information correlates distribution destination identification information of each specified distribution destination printing device and a distribution destination job index allocated to each division of the distribution print job by the specified distribution destination printing device, to a distribution source job index allocated to the distribution print job in a receiving order of the distribution print job,
the distributed printing monitor device acquiring the distribution management information created by the distributed printing control device, extracting the distribution destination identification information of each specified distribution destination printing device, which receives each division of the distribution print job, from the acquired distribution management information, receiving print job-related information regarding the distribution print job from the distribution destination printing device identified by the extracted distribution destination identification information, creating print status information representing the print status of each division of the distribution print job in each distribution destination printing device, based on the received print job-related information, and sending the created print status information to the print source device.

11. A distributed printing monitor system including plural printing devices, a distributed printing control device, and a distributed printing monitor device that are interconnected via a network, wherein the distributed printing control device distributes a distribution print job for distributed printing, which is received from the print source device via the network, to one or multiple distribution destination printing devices selected as distribution destinations of the distribution print job among the plural printing devices on the network, and the print source device is notified of a print status of each division of the distribution print job in each specified distribution destination printing device,
the print source device having the distributed printing monitor device as a built-in component,
the distributed printing control device receiving the distribution print job, specifying one or multiple distribution destination printing devices, distributing the distribution print job to the one or multiple specified distribution destination printing devices, and creating distribution management information, where the distribution management information correlates distribution destination identification information of each specified distribution destination printing device, a distribution destination job index allocated to each division of the distribution print job by the specified distribution destination printing device, and print source identification information, to a distribution source job index allocated to the distribution print job in a receiving order of the distribution print job,
the distributed printing monitor device acquiring the distribution management information created by the distributed printing control device, determining whether the print source identification information included in the acquired distribution management information matches with identification information of the print source device having the built-in distributed printing monitor device, and extracting, in response to matching as a result of the determination, the distribution destination identification information of each specified distribution destination printing device, which receives each division of the distribution print job, from the acquired distribution management information,
the distributed printing monitor device receiving print job-related information regarding the distribution print job from the distribution destination printing device identified by the extracted distribution destination identification information, creating print status information representing the print status of each division of the distribution print job in each distribution destination printing device, based on the received print job-related information, and displaying the created print status information on the print source device.

12. A distributed printing monitor system including plural printing devices, a distributed printing control device, and a distributed printing monitor device that are interconnected via a network, wherein the distributed printing control device distributes a distribution print job for distributed printing, which is received from the print source device via the network, to one or multiple distribution destination printing devices selected as distribution destinations of the distribution print job among the plural printing devices on the network, and the print source device is notified of a print status of each division of the distribution print job in each specified distribution destination printing device,
the print source device having the distributed printing monitor device as a built-in component,
the distributed printing control device receiving the distribution print job, specifying one or multiple distribution destination printing devices, distributing the distribution print job to the one or multiple specified distribution destination printing devices, and creating distribution management information, where the distribution management information correlates distribution destination identification information of each specified distribution destination printing device and a distribution destination job index allocated to each division of the distribution print job by the specified distribution destination printing device, to a distribution source job index allocated to the distribution print job in a receiving order of the distribution print job,
the distributed printing control device receiving a print status information transmission request from the distributed printing monitor device, extracting the distribution destination identification information of each specified distribution destination printing device, which receives each division of the distribution print job, from the created distribution management information, acquiring print job-related information regarding the distribution print job from the distribution destination printing device identified by the extracted distribution destination identification information, creating print status information representing the print status of each division of the distribution print job in each distribution destination printing device, based on the acquired print job-related information, and sending the created print status information to the distributed printing monitor device,
the distributed printing monitor device receiving the print status information sent from the distributed printing control device in response to the print status information transmission request, and displaying the received print status information on the print source device.

13. A distributed printing control method that distributes each distribution print job for distributed printing, which is received from a print source device via a network, to one or multiple distribution destination printing devices selected as distribution destinations of the distribution print job,
the distributed printing control method comprising the steps of:
(a) receiving a distribution print job and specifying one or multiple distribution destination printing devices;
(b) creating distribution management information, where the distribution management information correlates distribution destination identification information of each specified distribution destination printing device and a distribution destination job index allocated to each division of the distribution print job by the specified distribution destination printing device, to a distribution source job index allocated to the distribution print job in a receiving order of the distribution print job; and
(c) distributing the distribution print job to the one or multiple specified distribution destination printing devices.

14. A distributed printing monitor method that monitors a print status of each division of a distribution print job for distributed printing, which is sent via a network from a print source device to a distributed printing control device on the network, where the distributed printing control device specifies one or multiple distribution destination printing devices as distribution destinations of the distribution print job and distributes the distribution print job to the one or multiple specified distribution destination printing devices,
the distributed printing monitor method comprising the steps of
(a) acquiring distribution management information created by and sent from the distributed printing control device, where the distribution management information correlates distribution destination identification information of each specified distribution destination printing device, a distribution destination job index allocated to each division of the distribution print job distributed to the specified distribution destination printing device, and distribution source identification information of the print source device, to a distribution source job index allocated to the distribution print job in a receiving order of distribution print jobs;
(b) extracting the distribution destination identification information of each specified distribution destination printing device, which receives each division of the distribution print job, from the acquired distribution management information, and receiving print job-related information regarding the distribution print job from the distribution destination printing device identified by the extracted distribution destination identification information; and
(c) creating print status information representing a print status of each division of the distribution print job in each distribution destination printing device, based on the received print job-related information.

15. A distributed printing status monitoring method that causes a distributed printing control device on a network to distribute a distribution print job for distributed printing, which is received from a print source device via the network, to one or multiple distribution destination printing devices selected as distribution destinations of the distribution print job and enables the print source device to be notified, by a distributed printing monitor device on the network, of a print status of each division of the distribution print job in each specified distribution destination printing device,
the distributed printing status monitoring method comprising the steps of:
(a) causing the distributed printing control device to receive the distribution print job, to specify one or multiple distribution destination printing devices, and to distribute the distribution print job to the one or multiple specified distribution destination printing devices;
(b) causing the distributed printing control device to create distribution management information, where the distribution management information correlates distribution destination identification information of each specified distribution destination printing device and a distribution destination job index allocated to each division of the distribution print job by the specified distribution destination printing device, to a distribution source job index allocated to the distribution print job in a receiving order of the distribution print job;
(c) causing the distributed printing monitor device to acquire the distribution management information created by the distributed printing control device, to extract the distribution destination identification information of each specified distribution destination printing device, which receives each division of the distribution print job, from the acquired distribution management information, and to receive print job-related information regarding the distribution print job from the distribution destination printing device identified by the extracted distribution destination identification information; and
(d) causing the distributed printing monitor device to create print status information representing the print status of each division of the distribution print job in each distribution destination printing device, based on the received print job-related information, and to send the created print status information to the print source device.

16. A distributed printing status monitoring method that causes a distributed printing control device on a network to distribute a distribution print job for distributed printing, which is received from a print source device via the network, to one or multiple distribution destination printing devices selected as distribution destinations of the distribution print job and enables the print source device to be notified, through a built-in distributed printing monitor device in the print source device, of a print status of each division of the distribution print job in each specified distribution destination printing device,
the distributed printing status monitoring method comprising the steps of:
(a) causing the distributed printing control device to receive the distribution print job, to specify one or multiple distribution destination printing devices, and to distribute the distribution print job to the one or multiple specified distribution destination printing devices;
(b) causing the distributed printing control device to create distribution management information, where the distribution management information correlates distribution destination identification information of each specified distribution destination printing device, a distribution destination job index allocated to each division of the distribution print job by the specified distribution destination printing device, and print source identification information, to a distribution source job index allocated to the distribution print job in a receiving order of the distribution print job;
(c) causing the distributed printing monitor device to acquire the distribution management information created by the distributed printing control device, to determine whether the print source identification information included in the acquired distribution management information matches with identification information of the print source device having the built-in distributed printing monitor device, to extract, in response to matching as a result of the determination, the distribution destination identification information of each specified distribution destination printing device, which receives each division of the distribution print job, from the acquired distribution management information, and to receive print job-related information regarding the distribution print job from the distribution destination printing device identified by the extracted distribution destination identification information; and
(d) causing the distributed printing monitor device to create print status information representing the print status of each division of the distribution print job in each distribution destination printing device, based on the received print job-related information, and to display the created print status information on the print source device.

17. A distributed printing status monitoring method that causes a distributed printing control device on a network to distribute a distribution print job for distributed printing, which is received from a print source device via the network, to one or multiple distribution destination printing devices selected as distribution destinations of the distribution print job and enables the print source device to be notified, through a built-in distributed printing monitor device in the print source device, of a print status of each division of the distribution print job in each specified distribution destination printing device,
the distributed printing status monitoring method comprising the steps of:
(a) causing the distributed printing control device to receive the distribution print job, to specify one or multiple distribution destination printing devices, and to distribute the distribution print job to the one or multiple specified distribution destination printing devices;
(b) causing the distributed printing control device to create distribution management information, where the distribution management information correlates distribution destination identification information of each specified distribution destination printing device and a distribution destination job index allocated to each division of the distribution print job by the specified distribution destination printing device, to a distribution source job index allocated to the distribution print job in a receiving order of the distribution print job;
(c) causing the distributed printing control device to receive a print status information transmission request from the distributed printing monitor device, to extract the distribution destination identification information of each specified distribution destination printing device, which receives each division of the distribution print job, from the created distribution management information, and to acquire print job-related information regarding the distribution print job from the distribution destination printing device identified by the extracted distribution destination identification information;
(d) causing the distributed printing control device to create print status information representing the print status of each division of the distribution print job in each distribution destination printing device, based on the acquired print job-related information, and to send the created print status information to the distributed printing monitor device,
(e) causing the distributed printing monitor device to receive the print status information sent from the distributed printing control device in response to the print status information transmission request, and to display the received print status information on the print source device.

18. A computer program product that is executed to distribute each distribution print job for distributed printing, which is received from a print source device via a network, to one or multiple distribution destination printing devices selected as distribution destinations of the distribution print job,
the computer program product comprising:
a first program code of receiving a distribution print job and specifying one or multiple distribution destination printing devices;
a second program code of creating distribution management information, where the distribution management information correlates distribution destination identification information of each specified distribution destination printing device and a distribution destination job index allocated to each division of the distribution print job by the specified distribution destination printing device, to a distribution source job index allocated to the distribution print job in a receiving order of the distribution print job;
a third program code of distributing the distribution print job to the one or multiple specified distribution destination printing devices; and
a computer readable medium that stores the first to third program codes.

19. A computer program product that is executed to monitor a print status of each division of a distribution print job for distributed printing, which is sent via a network from a print source device to a distributed printing control device on the network, where the distributed printing control device specifies one or multiple distribution destination printing devices as distribution destinations of the distribution print job and distributes the distribution print job to the one or multiple specified distribution destination printing devices,
the computer program product comprising:
a first program code of acquiring distribution management information created by and sent from the distributed printing control device, where the distribution management information correlates distribution destination identification information of each specified distribution destination printing device, a distribution destination job index allocated to each division of the distribution print job distributed to the specified distribution destination printing device, and distribution source identification information of the print source device, to a distribution source job index allocated to the distribution print job in a receiving order of distribution print jobs;
a second program code of extracting the distribution destination identification information of each specified distribution destination printing device, which receives each division of the distribution print job, from the acquired distribution management information, and receiving print job-related information regarding the distribution print job from the distribution destination printing device identified by the extracted distribution destination identification information;
a third program code of creating print status information representing a print status of each division of the distribution print job in each distribution destination printing device, based on the received print job-related information; and
a computer readable medium that stores the first to third program codes.
